(19) United States
(12) Patent Application Publication
(10) Pub. No.: US 2006/0069457 A1
(43) Pub. Date: Mar. 30, 2006

(54) Dynamically adjustable shared audio processing in dual core processor

(75) Inventors: Ketan P. Malani, Murphy, TX (US); Shiv Ramamurthi, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/949,968

(22) Filed: Sep. 24, 2004

(51) Int. Cl. G06F 17/00

(52) U.S. Cl. 700/94

(57) ABSTRACT

An electronic device (10), comprising a first core (20), operable to process a number N of audio source streams, and a second core (24), operable to process a number M of audio source streams. The device further comprises circuitry (22_{RE}) for indicating an extent of at least one resource use of the second core. The device further comprises circuitry (22_{AM}) for assigning an audio source stream to either the number N of audio source streams or the number M of audio source streams in response to the circuitry for indicating an extent of at least one resource use of the second core.

### CROSS-REFERENCES TO RELATED APPLICATION

Not Applicable.

### STATEMENT REGARDING FEDERALLY SPONSORED RESEARCH OR DEVELOPMENT

Not Applicable.

### BACKGROUND OF THE INVENTION

The present embodiments relate to electronic processors and are more particularly directed to an electronic device implementing a dual core single integrated circuit processor (or controller) with dynamically adjustable shared audio processing.

Electronic devices are extremely prevalent and beneficial in today's society and are constantly being improved due to consumer and user demand. One example has been the portable or cellular telephone marketplace, which has seen great advances in the last many years. These phones have evolved beyond provision of voice services alone and are now accommodating greater amounts of data and are providing various additional features, more advanced operating systems, and additional programming. For example, so-called “smart phones” are envisioned as having a large impact on upcoming generations of cellular phones. Also, various personal digital assistants (“PDAs”) are still succeeding in the marketplace and may do so for the foreseeable future. Further, the functionality of cellular phones and PDAs are now beginning to overlap with the possibility of a greater combination of the functionality of these devices into a single unit in the future. In any event, such devices now provide or will provide various additional programs, including but not limited to games and other business or personal applications. Further, many of the programs have evolved to support more complex audio signals so as to provide the user a more enjoyable or meaningful experience.

One contemporary approach to the electronics within the devices discussed above is the use of a single integrated circuit that includes two different cores, where those cores may be developed by different entities and where each supports a different, but possibly overlapping, set of functionality. Such devices are also sometimes incorporated into so-called system-on-chip (“SOC”) processors. For example, the Tungsten T PDA currently sold as a PalmOne product includes such a dual-core processor, where one core is known is a digital signal processor (“DSP”), provided by Texas Instruments Incorporated, and the other core is a general-purpose processor and is known as an advanced risc (“reduced instruction set computer”) machine (“ARM”), designed by a company known as ARM Limited; these cores are combined in a single integrated circuit processor by Texas Instruments Incorporated and referred to as an OMAP. A Texas Instruments Incorporated OMAP is also sold by Motorola in their A925 device, and it is also sold in other commercially-available products. In these dual-core devices, each core has specific respective resources, where by example both the ARM and DSP often have respective ports, peripherals, and may have both internal memory as well as access to external (and possibly shared) memory. Further, both devices have specific respective capabilities and, as such, the demands of a device program are typically split so as to utilize the functionality and resources of the core that best meet the program's demand. The ARM is typically designed to operate according to a high-level operating system, such as WinCE, Linux, Symbian, and the like, and as a RISC machine it includes a reduced pipeline so as to execute an understood instruction set with more instructions executed in unit time as compared to a non-RISC machine. Moreover, the ARM typically includes a sound mixer as well as a sampling rate converter, both of which are directed to processing the raw data from a number of audio sources, where that raw data is ultimately provided by processing an audio file (or files) through one or more layers of abstraction of the high-level operating system. The DSP, on the other hand, typically operates without that type of an operating system and processes data while often executing multiple instructions in a single cycle and consistent with the particular demands of the device in which the core is used. The DSP also often has specific circuitry for processing specific types or formats of data and for executing complex computations, such as a specialized arithmetic logic unit as well as a multiply-accumulate unit(s). Thus, the DSP may be well suited for accelerating specific functions as compared to what may or may not be achievable via the more general purpose processing functionality of the ARM.

In connection with the preferred embodiments described later, the present inventors recognize limitations of certain prior art dual-core approaches. Specifically, often one or both cores of a dual-core processor may function quite desirably for certain applications, yet changes in future advancements may expose limitations of one or both cores. Indeed, for purposes of efficiency, often a core may be designed so as to provide a certain set of functions and, thus, the cost of the core is reduced as opposed to a core that may support additional functions that may be extraneous and unnecessary for a certain application. However, with the progress in electronic devices, the demands of applications may increase and thereby exceed the functionality of one of the cores on the dual (or multi-) core processor. Thus, to accommodate that progress, some approaches call for considerable core re-designs, which are often undesirable due to factors such as cost and delay to market.

As a key example of the above-discussed limitations, the present inventors have observed that user demand for functionality in cell phones, PDAs and the like is following a trend that will seek to support mixing of an increasing number of audio sources. In this sense, each audio source is intended to mean a single stream of raw audio data (either mono or stereo). Such a stream may be from a source that at a higher level is encoded to include a header identifying various attributes of the channel as well as the raw data that is available once the header is removed, separated, or interpreted in view of that data; in contemporary applications, each such audio source is in the form of a file that may take various forms, such as a WAV, MP3, AAC, AAC+, narrow band AMR, wide band AMR, and still others known in the art. Alternatively, the audio source may represent a file that provides only the stream of raw audio data. The raw audio data is always pulse code modulated and, thus, is referred to as PCM data. In any event, the trend demanding an increase in the number of mixed audio sources places a greater demand on prior art dual-core processors. In the current state of the art, often the DSP is required to process compressed audio sources while the ARM may process raw data audio sources, unless the ARM has a sufficiently complex decoding algorithm that may be part of its operating system. Further, certain resources in or available to the DSP are fixed, such as its internal memory and the rate at which it may execute its instructions, typically referred to as MIPS (millions of instructions per second). Thus, for each audio source processed by the DSP, a corresponding amount of those resources are used, thereby making unavailable those resources for use by the DSP for other processes. As a result, typically there is a statically fixed limit on the number of such channels that are permitted to be processed by the DSP, where the number is often established by the original equipment manufacturer. Thus, should an application running on the processor request audio processing of the DSP beyond that limit, then typically the request is either ignored by the DSP or some other action is taken, where in any case the request is not serviced. As such, the additional audio source is not processed and the device user is not presented with the sound corresponding to that source. Moreover, this problem will likely become worse as additional sound mixing is sought on future cell phone, PDA devices, or the like.

As a result of the preceding, there arises a need to address the drawbacks of the prior art as is achieved by the preferred embodiments described below.

### BRIEF SUMMARY OF THE INVENTION

In one preferred embodiment, there is an electronic device, comprising a first core, operable to process a number N of audio source streams, and a second core, operable to process a number M of audio source streams. The device further comprises circuitry for indicating an extent of at least one resource use of the second core. The device further comprises circuitry for assigning an audio source stream to either the number N of audio source streams or the number M of audio source streams in response to the circuitry for indicating an extent of at least one resource use of the second core.

Other aspects are also disclosed and claimed.

### BRIEF DESCRIPTION OF THE SEVERAL VIEWS OF THE DRAWING

FIG. 1 illustrates an example of a wireless telephone handset 10 into which the preferred embodiment is implemented.

FIG. 2 illustrates an exemplary architecture for handset 10 according to one preferred embodiment.

FIG. 3 illustrates various aspects relating to single integrated circuit 22 and its two cores core, 20 and DSP 24, as generally pertaining to those devices as they relate to audio processing.

FIG. 4 illustrates a flowchart of a method 100 of operation of various aspects of integrated circuit 22.

### DETAILED DESCRIPTION OF THE INVENTION

The present invention is described below in connection with a preferred embodiment, namely as implemented into an electronic device that implements a dual (or multi-) core processor, such as may be included in a cellular telephone or a personal digital assistant (“PDA”), by ways of example. Still other electronic devices may implement such a processor as well, as may be evident in the wireless art such as GPS enabled devices. The present inventors believe that this invention is especially beneficial in such applications. However, the invention also may be implemented in, and provide significant benefit to, other electronic devices as well. Accordingly, it is to be understood that the following description is provided by way of example only and is not intended to limit the inventive scope.

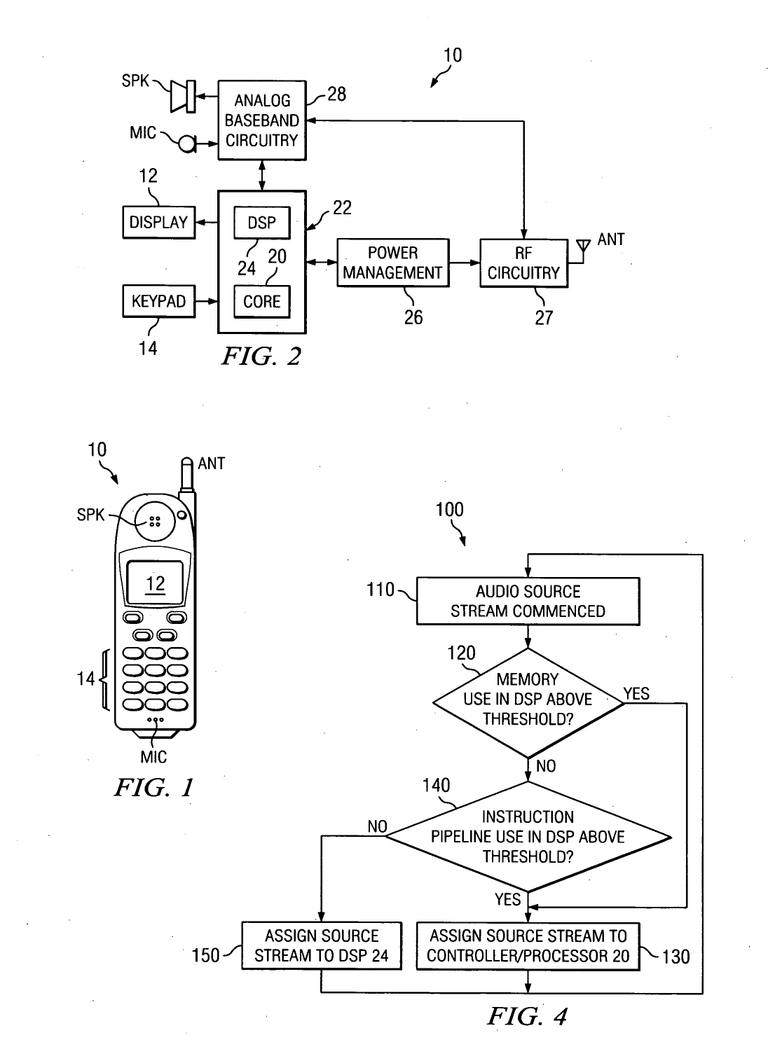

FIG. 1 illustrates an example of a of wireless telephone handset 10 into which the preferred embodiment is implemented. In this example, handset 10 provides the conventional human interface features, including microphone MIC, speaker SPK, visual display 12, and keypad 14. Keypad 14 includes the usual keys for a wireless telephone handset, including numeric keys 0 through 9, the * and # keys, and other keys as in conventional wireless telephone handsets. According to the preferred embodiment of the invention, speaker SPK is operable to receive signals and play different sound files that are mixed by circuitry within handset 10 in a manner so as to appear to a human user as to simultaneously play different streams of sounds, as further detailed later.

Referring now to FIG. 2, the construction of an exemplary architecture for handset 10 according to a preferred embodiment of the invention is now described. Of course, the particular architecture of a wireless handset (or other device within the inventive scope) may vary from that illustrated in FIG. 2, and as such the architecture of FIG. 2 is presented only by way of example.

As shown in FIG. 2, the functionality of handset 10 is generally controlled by a core 20 that is part of a single integrated circuit 22 (or “processor”), where a digital signal processor (“DSP”) 24 is also formed on integrated circuit 22. Thus, core 20 and DSP 24 form a first and second core, respectively, on integrated circuit 22. Core 20 is preferably a programmable logic device, such as a microprocessor or microcontroller, that controls the operation of handset 10 according to a computer program or sequence of executable operations stored in program memory. Preferably, the program memory is on-chip with core 20, but alternatively may be implemented in read-only memory (“ROM”) or other storage in a separate integrated circuit. The computational capability of core 20 depends on the level of functionality required of handset 10, including the “generation” of wireless services for which handset 10 is to be capable. As known in the art, modern wireless telephone handsets can have a great deal of functionality, including the capability of Internet web browsing, email handling, digital photography, game playing, PDA functionality, and the like. Such functionality is in general controlled by core 20. High-performance processors that are suitable for use as core 20 include the advanced risc (“reduced instruction set computer”) machine (“ARM”) designed by a company known as ARM Limited.

In the example of FIG. 2, core 20 is coupled to DSP 24, visual display 12, keypad 14, and a power management function 26. DSP 24 performs the bulk of the digital signal processing for signals to be transmitted and signals received by handset 10. These functions include the necessary digital filtering, coding and decoding, digital modulation, and the like. As detailed later, DSP 24 also is operable to process audio source streams. Examples of DSPs suitable for use as DSP 24 in handset 10 according to this embodiment include the TMS320c5x family of digital signal processors available from Texas Instruments Incorporated. Further, note that DSPs that are comparable in various respects are available in combined form with the above-discussed ARM core on a single integrated circuit such as circuit 22 as a combined processor referred to by Texas Instruments Incorporated as an OMAP, although they do not include certain audio processing functions detailed later. Power management function 26 distributes regulated power supply voltages to various circuitry within handset 10 and manages functions related to charging and maintenance of the battery of handset 10, including standby and power-down modes to conserve battery power.

Handset 10 also includes radio frequency (“RF”) circuitry 27, which is coupled to an antenna ANT and to an analog baseband circuitry 28. RF circuitry 27 includes such functions as necessary to transmit and receive the RF signals at the specified frequencies to and from the wireless telephone communications network. RF circuitry 27 is thus contemplated to include such functions as modulation circuitry and RF input and output drivers. Analog baseband circuitry 28 processes the signals to be transmitted (as received from microphone MIC) prior to modulation, and the received signals (to be output over speaker SPK) after demodulation (hence in the baseband), to apply the necessary filtering, coding and decoding, and the like. Further, as introduced earlier and further detailed below, signals provided from single integrated circuit 22 in some instances represent mixed audio streams which, once processed through analog baseband circuitry 28 and played by speaker SPK, provide the user of handset 10 with a collective sound that impresses as the simultaneous playing of two or more audio streams. Such resulting sounds may be used for notification, entertainment, gaming, and the like. Lastly, typical functions included within analog baseband circuitry 28 include an RF coder/decoder (“CODEC”), a voice CODEC, speaker amplifiers, and the like, as known in the art.

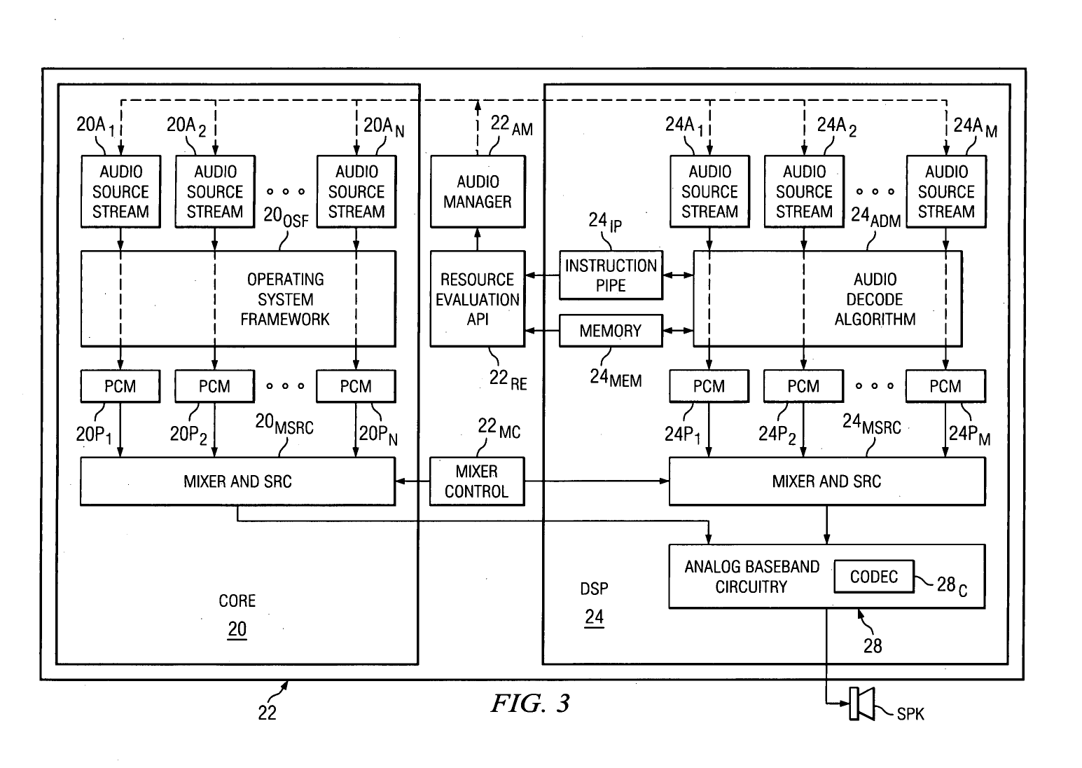

Referring now to FIG. 3, various aspects relating to single integrated circuit 22 and its two cores, core 20 and DSP 24, are now further explored in connection with the preferred embodiments. By way of introduction, the illustration of FIG. 3 and the following discussion pertains generally to the operation of the depicted devices as they relate to audio processing. Both devices are known to be capable of numerous other functions and are contemplated as including such functions within the present inventive scope, yet those functions are neither shown nor discussed so as to focus the discussion on the novel audio processing aspects. Moreover, such functionality is ascertainable by one skilled in the art.

Looking to the depiction of core 20 in FIG. 3, it is shown as processing a number N of audio source streams, shown separately as audio source streams 20A₁, 20A₂, . . . 20A_{N}. The descriptor “audio source stream” is intended to indicate a separable data set of raw audio data (either mono or stereo). For reasons more clear below, each audio source stream is shown as controlled (illustrated with a dashed line) by an audio manager 22_{AM}, where audio manager 22_{AM} is a functional aspect that may be considered to be part of either core 20 or DSP 24, so for sake of FIG. 3 it is shown generally as just part of the overall processor 22 which includes both of those devices.

Each audio source stream 20Aₓ is coupled to an operating system framework 20_{OSF}, which includes various aspects based on the particular high-level operating system of core 20, such as WinCE, Linux, Symbian, and the like. The capability of the operating system determines the type of audio source that may be used for each audio source stream 20Aₓ. In one embodiment, operating system framework 20_{OSF} does not include an audio decoding algorithm sufficient to decode encoded audio formats, such as MP3, AAC, AAC+, narrow band AMR, wide band AMR, and others; in this case, therefore, only already-decoded formats, such as WAV files, are permitted to be used for each audio application 20Aₓ. In an alternative embodiment, operating system framework 20_{OSF} includes an audio decoding algorithm sufficient to decode the above-mentioned encoded formats; in this case, therefore, both already-decoded and encoded formats are permitted to be used for each audio source stream 20Aₓ.

In either of the above-described operating system embodiments, for each audio source stream 20Aₓ, operating system framework 20_{OSF} produces a corresponding pulse code modulation (“PCM”) raw data output 20Pₓ. Thus, shown in FIG. 3 are PCM 20P₁, PCM 20P₂, through PCM 20P_{N}, corresponding respectively to audio source streams 20A₁, 20A₂, through 20A_{N}. Each of the PCMs 22Pₓ is connected to a mixer and sampling rate converter (“SRC”) block 20_{MSRC}. The functions of mixing and SRC are known in the art. Generally, mixing is the combining of more than one audio stream into a single stream and SRC is used to accommodate a change in data rate that is necessitated when the audio data stream operates at a frequency that differs from that of circuitry (e.g., a CODEC) in analog baseband circuitry 28. For example, in a contemporary application, the audio source stream may operate at a frequency of 44 kHz for music or 8 kHz for speech, while the CODEC operates at 48 kHz. Mixer and SRC block 20_{MSRC} is subject to control by a mixer control block 22_{MC}, where block 22_{MC} is a functional aspect that may be considered to be part of either core 20 or DSP 24, so for sake of FIG. 3 it also is shown generally as just part of the overall integrated circuit 22 which includes both of those devices. In general, block 22_{MC} controls the mixing and SRC functions and also causes the implementation, by mixer and SRC 20_{MSRC}, of any desired audio enhancement features, such as gain, mute, audio panning and others that may be ascertained by one skilled in the art.

Looking to the depiction of DSP 24 in FIG. 3, with respect to audio processing as is emphasized in that Figure, certain aspects are comparable in certain respects to those shown and discussed above with respect to core 20. Indeed, for some audio processing, the functions are generally interchangeable in that either core may process some audio source streams. However, certain distinctions and limitations also exist, as does an interaction between the two cores as discussed below, all of which permit optimizing use of the resources of both cores with respect to audio processing according to the preferred embodiments.

With respect to DSP 24 in FIG. 3, it is shown as processing a number M of audio source streams, shown separately as audio source streams 24A₁, 24A₂, . . . , 24A_{M}, where the descriptor “audio source stream” is as described above. Again for reasons more clear below, each audio source stream is shown as controlled (illustrated with a dashed line) by audio manager 22_{AM}, which recall may be part of either core 20 or DSP 24 or generally as part of the overall integrated circuit 22. However, in a preferred embodiment, it is contemplated that DSP 24, relative to core 20, is more application-specific with respect to audio processing and, hence, it is desirable that each audio source stream 24Aₓ may be either a high-level encoded application or a raw data stream. Thus, in this regard, each audio source stream 24Aₓ is coupled to an audio decode algorithm 24_{ADE}, which operates to decode any high-level encoded audio source stream or to remove and/or process the header from any decoded or raw data stream (e.g., WAV file) and to produce a corresponding PCM raw data output 24Pₓ. Thus, shown in FIG. 3 are PCM 24P₁, PCM 24P₂, through PCM 24P_{M} corresponding respectively to audio source streams 24A₁, 24A₂, through 24A_{M}. Each of the PCMs 24Pₓ is connected to a mixer and SRC block 24_{MSRC}, which operates generally in the same manner as mixer and SRC block 20_{MSRC} of core 20, but of course SRC block 24_{MSRC} operates with respect to the PCMs 24Pₓ of DSP 24. In addition and as further appreciated later, an additional input to mixer and SRC block 24_{MSRC} is the output of mixer and SRC block 24_{MSRC} of core 20; thus, the mixed output of core 20 may in effect be treated as a single additional input stream to mixer and SRC block 24_{MSRC} of DSP 24, thereby to be mixed with the additional inputs 24₁, 24₂, through 24_{M}. Lastly, mixer and SRC block 24_{MSRC} also is subject to control by mixer control block 22_{MC}.

Looking at additional aspects of DSP 24 in FIG. 3, it also includes an instruction pipeline 24_{IP} and an internal memory 24_{MEM}, which are both shown coupled to audio decode algorithm 24_{ADM} because those devices may be used in connection with the performance of that algorithm according to principles known in the art. Additionally, while not shown, one skilled in the art will appreciate that instruction pipeline 24_{IP} and an internal memory 24_{MEM} are also to be used as resources for other operations of DSP 24, including those not necessarily related to audio processing. For example, in an instance where DSP 24 implements its own operating system, such an operating system may consume a considerable portion of the available storage space in memory 24_{MEM} (which, in contemporary examples may be on the order of 80 k). DSP 24 also includes a resource evaluation application programmer's interface (“API”) 24_{RE}. As its name suggests and as further detailed in connection with FIG. 4, below, resource evaluation API 24_{RE} evaluates the present use of certain resources on DSP 24 and produces signals via an API (or other interface) to indicate the extent of such usage. Moreover, in the preferred embodiment, the resources monitored in this manner by resource evaluation API 24_{RE} include the extent of use of memory 24_{MEM} and of instruction pipeline 24_{IP}. Note that each such measure may be determined and indicated in various manners as ascertainable by one skilled in the art, where for example the percentage of total available use may be evaluated and recorded, and this example is further used below in connection with FIG. 4.

Concluding FIG. 3, an audio manager 22_{AM} is shown, where audio manager 22_{AM} is a functional aspect that also may be considered to be part of either core 20 or DSP 24, so for sake of FIG. 3 it also is shown generally as just part of the overall integrated circuit 22 which includes both of those devices. As detailed later in connection with FIG. 4, audio manager 22_{AM} is operable to receive resource use indications from resource evaluation API 24_{RE} and in response to control the destination to which audio source streams are presented, that is, whether an application stream is presented to core 20 or to DSP 24. Finally, note that mixer and SRC block 24_{MSRC} is shown to provide an output to analog baseband circuitry 28, which recall was discussed earlier in connection with FIG. 2. Thus, this output is a mix of the PCMs 24₁ through 24_{M} from audio decode algorithm 24_{ADM} as well as the stream from mixer and SRC block 24_{MSRC} of core 20 (which may include itself a mix of more than one PCM). In any event, ultimately the mixed signals that connect to analog baseband circuitry, as shown in FIG. 3, are further connected to a CODEC 28_{C} within analog baseband circuitry 28, which processes those outputs with a resulting signal applied to speaker SPK so that responsive sounds are played by that speaker to the user of handset 10.

FIG. 4 illustrates a flowchart of a method 100 of operation of various aspects of integrated circuit 22 in connection with the inventive scope. By way of introduction, note that the use of a flowchart is merely to explain various functional concepts and steps, where the order of these steps may be adjusted and where they may be represented in an alternative fashion, such as in a state diagram. Moreover, the steps of FIG. 4 are only directed to certain aspects pertaining to the management of audio sources, while one skilled in the art will readily appreciate that various other functions may occur with respect to integrated circuit 22, either simultaneously or in addition to those set forth in FIG. 4. Lastly, note that the steps of method 100 may be achieved by various combinations of either software or hardware circuitry, either alone or together or where certain circuitry may be caused to perform operations in response to software, as may be realized by one skilled in the art.

Turning to method 100 of FIG. 4, it commences with a step 110 which indicates that an audio source stream is to be commenced. Such an event may take place in numerous instances such as through one or more programs running on integrated circuit 22 and possibly also in response to a user input or user interaction. In any event, step 110 is intended to demonstrate that an event has occurred which commences the desire to eventually play via speaker SPK the sound corresponding to an audio source stream. Also, for the present discussion, assume that the audio source stream to be commenced is in general capable of being processed by either core 20 or DSP 24, that is, it is either a non-encoded stream or, if encoded, then core 20 has sufficient decoding capability so as to decode the stream. Next, method 100 continues from step 110 to step 120.

Step 120 determines whether memory usage by DSP 24 is beyond a threshold, where the threshold may be statically preset or dynamically adjusted, in either case based on considerations ascertained by one skilled in the art. Step 120 is preferably achieved by a query of audio manager 22_{AM} to resource evaluation API 24_{RE}. Recall that the latter operates to evaluate the extent of present usage of internal memory 24_{MEM}. Thus, in step 120, that evaluation is reported to audio manager 22_{AM}, and audio manager 22_{AM} in response determines whether the usage is above the step 120 threshold. For sake of an example, assume that the threshold is 50%, so that audio manager 22_{AM} determines whether the usage of internal memory 24_{MEM} is greater than 50% of the available storage space in that memory. If the step 120 threshold (e.g., 50%) of memory-use is exceeded, then method 100 continues from step 120 to step 130. If the step 120 threshold (e.g., 50%) of memory-use is not exceeded, then method 100 continues from step 120 to step 140.

Step 140 determines whether instruction pipeline usage by DSP 24 is beyond a threshold, where the threshold, like that of step 120, also may be statically preset or dynamically adjusted based on considerations ascertained by one skilled in the art. Step 140 also is preferably achieved by a query of audio manager 22_{AM} to resource evaluation API 24_{RE}, but here in connection with the operation of resource evaluation API 24_{RE} to evaluate the extent of present usage of instruction pipeline 24_{IP}. Thus, in step 140, that evaluation is reported to audio manager 22_{AM}, and in response audio manager 22_{AM} determines whether the usage is above the step 140 threshold. For sake of an example, assume that instruction pipeline 24_{IP} is capable of executing a number X of MIPS, then assume further that the threshold is 65%, so that audio manager 22_{AM} determines whether the usage of instruction pipeline 24_{IP} is greater than 65% of the X MIPS. If the step 140 threshold (e.g., 65%) of X MIPS is exceeded, then method 100 continues from step 140 to step 130. If the step 140 threshold (e.g., 65%) of X MIPS is not exceeded, then method 100 continues from step 130 to step 150.

Steps 130 and 150 represent alternatives for the assignment of processing of an audio source stream, that commenced in step 110, to either core 20 or DSP 24. Particularly, recall that step 130 is reached when either the step 120 or the step 140 threshold is exceeded. In response, in step 130 audio manager 22A_{M} controls the audio source stream to be processed by core 20 as one of streams 20A₁ through 20A_{N}, and as discussed earlier, they are then processed and mixed by mixer and SRC block 20_{MSRC}, then being provided as an input to mixer and SRC block 24_{MSRC} of DSP 24. Thereafter, those sounds are mixed with any one or more of PCMs P24₁ through P24_{M} of DSP 24, and ultimately sounds corresponding to the resulting mixed stream are played at speaker SPK, thereby impressing upon the user of handset 10 an effect of a combined or simultaneous playing of multiple different sounds. Conversely, recall that step 150 is reached when neither the step 120 nor the step 140 threshold is exceeded. In response, in step 150 audio manager 22_{AM} controls the audio source stream to be processed by DSP 24 as one of streams 24A₁ through 24A_{M}, and as discussed earlier, they are then processed and mixed by mixer and SRC block 24_{MSRC} of DSP 24, potentially further mixed with any input from SRC block 24_{MSRC} of core 20, and ultimately again sounds corresponding to the resulting mixed stream are played at speaker SPK.

As a result of the two alternatives provided by steps 130 and 150, various observations now may be made with respect to the present inventive scope. As a first observation, the preferred embodiments are such that as each new audio source stream is to be commenced and processed by integrated circuit 22, method 100 causes that application stream to be assigned to one of the two cores on that circuit and in response to the extent resources are being used on DSP 24. Preferably, those resources include one or both of internal memory usage or instruction pipeline usage on DSP 24, although other resources could be contemplated by one skilled in the art. Also in this regard, the dashed lines shown in FIG. 3 between audio manager 22_{AM} and any of the audio source streams 20Aₓ or 24Aₓ are intended to depict that each such application stream has been assigned to the corresponding one of either core 20 or DSP 24; thus, in the illustrated example, audio manager 22_{AM} has assigned N audio applications to be processed by core 20 and M audio applications to be processed by DSP 24. As a second observation, note therefore that system resources with respect to integrated circuit 22 as a whole may be better managed as opposed to the prior art. Specifically, dynamic adjustments are permitted as to the limit of audio channels that may be processed by DSP 24, so at times when the resources of DSP 24 are needed for processing data other than audio applications, those resources may be available for such uses while audio applications are instead directed to be processed by core 20. However, at times when resources on DSP 24 are freely available, then more audio source streams may be assigned to, and processed by, DSP 24, thereby potentially permitting an even greater number of overall audio streams to be processed collectively by both DSP 24 and core 20. Note, of course, that limitations may still arise where collectively the resources of DSP 24 and core 20 are insufficient to process a large number of audio source streams. Also a limitation may arise if other constraints exist, such as in a case where operating system framework 20_{OSF} does not include a decoding algorithm; in this case, encoded audio source streams are therefore not possibly processed by core 20 and, instead, must be assigned to DSP 24. However, if the resource(s) monitored in connection with method 100 are beyond the then-established threshold(s), then DSP 24 also may not be available at that time to process the audio source streams. In any event, therefore, the number of streams that may be processed by DSP 24 are variable and in response to its resource use(s), thereby permitting greater flexibility of sound processing as compared to the prior art.

From the above, it may be appreciated that the preferred embodiments provide an improved electronic device implementing dynamically adjustable shared audio processing in a dual-core single integrated circuit. These embodiments include various aspects and advantages as compared to the prior art, as discussed above and as may be appreciated by one skilled in the art. Moreover, while the preferred embodiments have been shown by way of example, certain other alternatives have been provided and still others are contemplated. For example, while the resources monitored in connection with DSP 24 are stated to be memory usage and MIPS, still others may be monitored and factored into the determination of which core is assigned to process an audio source stream. As another example, step 120 is directed to internal memory of DSP 24 in that performance is highly sensitive to use of such memory due to its speed, although other memories including external memory also may be considered for purposes of that or a comparable resource evaluation step. As yet another example, the threshold for either of steps 120 and 140 may be changed, either statically in advance of, or dynamically during, operation of handset 10 to achieve a different apportionment of processing responsibility as between core 20 and DSP 24. Still other examples may be ascertained by one skilled in the art. Thus, the preceding discussion and these examples should further demonstrate that while the present embodiments have been described in detail, various substitutions, modifications or alterations could be made to the descriptions set forth above without departing from the inventive scope which is defined by the following claims.

1. An electronic device, comprising:
a first core, operable to process a number N of audio source streams;
a second core, operable to process a number M of audio source streams;
circuitry for indicating an extent of at least one resource use of the second core; and
circuitry for assigning an audio source stream to either the number N of audio source streams or the number M of audio source streams in response to the circuitry for indicating an extent of at least one resource use of the second core.

2. The device of claim 1 wherein the first core and the second core are formed on a single integrated circuit.

3. The device of claim 2:
wherein the first core comprises a general purpose processor; and
wherein the second core comprises a digital signal processor.

4. The device of claim 3 wherein the circuitry for indicating comprises circuitry for indicating an extent use of an internal memory of the second core.

5. The device of claim 4 wherein the circuitry for assigning comprises circuitry for determining whether the extent of at least one resource use exceeds a threshold.

6. The device of claim 5 wherein the circuitry for assigning comprises circuitry for determining whether the threshold is established as a static value.

7. The device of claim 5 wherein the circuitry for assigning comprises circuitry for determining whether the threshold is periodically adjusted as a dynamic value.

8. The device of claim 3 wherein the circuitry for indicating comprises circuitry for indicating an extent use of an instruction pipeline of the second core.

9. The device of claim 8 wherein the circuitry for assigning comprises circuitry for determining whether the extent of at least one resource use exceeds a threshold.

10. The device of claim 9 wherein the circuitry for assigning comprises circuitry for determining whether the threshold is established as a static value.

11. The device of claim 9 wherein the circuitry for assigning comprises circuitry for determining whether the threshold is periodically adjusted as a dynamic value.

12. The device of claim 3 wherein the circuitry for indicating comprises:
circuitry for indicating an extent use of an internal memory of the second core; and
circuitry for indicating an extent use of an instruction pipeline of the second core.

13. The device of claim 3 wherein the circuitry for indicating comprises circuitry for indicating an extent use of an external memory of the second core.

14. The device of claim 3 wherein the circuitry for assigning comprises circuitry for determining whether the extent of at least one resource use exceeds a threshold.

15. The device of claim 3 wherein the circuitry for assigning comprises circuitry for determining whether the threshold is established as a static value.

16. The device of claim 3 wherein the circuitry for assigning comprises circuitry for determining whether the threshold is periodically adjusted as a dynamic value.

17. The device of claim 3 wherein the first core is operable according to an operating system.

18. The device of claim 17 wherein the operating system is selected from a set consisting of WinCE, Linux, and Symbian.

19. The device of claim 17 wherein the operating system comprises an algorithm for decoding encoded audio source streams.

20. The device of claim 3:
wherein the first core comprises a mixer for mixing signals corresponding to the number N of audio source streams; and
wherein the second core comprises a mixer for mixing signals corresponding to the number M of audio source streams.

21. The device of claim 20 wherein a mixed output from the mixer of the first core provides an input to the mixer of the second core.

22. The device of claim 20 and further comprising:
analog conversion circuitry for receiving signals responsive to an output of the mixer of the first core and an output of the mixer of the second core; and
circuit for converting the signals into an audible sound.

23. The device of claim 22 wherein the circuit for converting the signals into an audible sound comprises at least one speaker.

24. The device of claim 1 wherein the first core, second core, circuitry for indicating, and circuitry for assigning are part of an electronic device selected from a set consisting of a telephone and a personal digital assistant.

25. An electronic device, comprising:
a first core, operable to process a number N of audio source streams, wherein the first core comprises a general purpose processor;
a second core, operable to process a number M of audio source streams, wherein the second core comprises a digital signal processor;
circuitry for indicating an extent of at least one resource use of the second core; and
circuitry for assigning an audio source stream to either the number N of audio source streams or the number M of audio source streams in response to the circuitry for indicating an extent of at least one resource use of the second core.

26. The device of claim 25 wherein the circuitry for assigning comprises circuitry for determining whether the extent of at least one resource use exceeds a threshold.

27. The device of claim 25 wherein the circuitry for indicating comprises circuitry for indicating an extent use of an internal memory of the second core.

28. The device of claim 25 wherein the circuitry for indicating comprises circuitry for indicating an extent use of an instruction pipeline of the second core.

29. The device of claim 25 wherein the circuitry for indicating comprises:
circuitry for indicating an extent use of an internal memory of the second core; and
circuitry for indicating an extent use of an instruction pipeline of the second core.

30. Computer programming for use in an electronic device comprising a first core, operable to process a number N of audio source streams, and a second core, operable to process a number M of audio source streams, the programming for causing the steps of:
indicating an extent of at least one resource use of the second core; and
assigning an audio source stream to either the number N of audio source streams or the number M of audio source streams in response to the step of indicating an extent of at least one resource use of the second core.

31. The programming of claim 30:
wherein the first core comprises a general purpose processor; and
wherein the second core comprises a digital signal processor.

32. The programming of claim 30 wherein the assigning step comprises determining whether the extent of at least one resource use exceeds a threshold.

33. The programming of claim 30 wherein the indicating step comprises indicating an extent use of an internal memory of the second core.

34. The programming of claim 30 wherein the indicating step comprises indicating an extent use of an instruction pipeline of the second core.

35. The programming of claim 30 wherein the indicating step comprises:
indicating an extent use of an internal memory of the second core; and
indicating an extent use of an instruction pipeline of the second core.
